(19) United States
(12) Patent Application Publication
(10) Pub. No.: US 2006/0276190 A1
(43) Pub. Date: Dec. 7, 2006

(54) Method and apparatus for implementing a handoff between radio access networks deployed under different radio access technologies

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/412,176

(22) Filed: Apr. 26, 2006

Related U.S. Application Data
(60) Provisional application No. 60/682,516, filed on May 19, 2005.
(60) Provisional application No. 60/694,953, filed on Jun. 29, 2005.

(51) Int. Cl. H04Q 7/20

(52) U.S. Cl. 455/436

(57) ABSTRACT

A method and apparatus for implementing a handoff between radio access networks (RANs) deployed under different radio access technologies (RATs) are disclosed. A wireless transmit/receive unit (WTRU) is equipped with at least two radio units to support the RATs. Each RAN sends a list of co-located RANs in the coverage area of the RAN to the WTRU. The WTRU stores the list and determines whether handoff criteria is met by one of the co-located RANs. The WTRU then initiates a handoff from a current RAN to a target RAN if the handoff criteria is met by the target RAN. Alternatively, the WTRU may send a measurement report to the current RAN, whereby the current RAN determines whether handoff criteria is met by a selected one of the co-located RANs and initiate a handoff to the selected RAN if the handoff criteria is met.

### CROSS REFERENCE TO RELATED APPLICATIONS

This application claims the benefit of U.S. provisional application Nos. 60/682,516 filed May 19, 2005,60/694,953 filed Jun. 29, 2005, which are incorporated by reference as if fully set forth.

### FIELD OF INVENTION

The present invention is related to wireless communication systems. More particularly, the present invention is related to a method and apparatus for implementing a handoff between radio access networks (RANs) deployed under different radio access technologies (RATs).

### BACKGROUND

Different types of wireless access systems have been developed to provide different types of services. Some examples of the wireless access systems include wireless local area networks (WLANs), (such as IEEE 802-based networks), and cellular networks, (such as universal mobile telecommunication systems (UMTS) terrestrial radio access network (UTRAN), an evolved UTRAN (E-UTRAN), a GPRS/EDGE radio access network (GERAN), or the like). Each of these networks have been developed and tailored to provide specific applications.

With the pervasive adoption of wireless communication networks in enterprise, residential and public domains, continuous connectivity can be supported as the users of such networks move from one network to another. With an emerging “always-on” scenario, wireless transmit/receive units (WTRUs), (i.e., mobile stations (MS)), are required to support multiple heterogeneous networks. Thus, a seamless handoff between these networks is desired.

### SUMMARY

The present invention is related to a method and apparatus for implementing a handoff between RANs deployed under different RATs. A WTRU is equipped with at least two radio units to support the RATs. Each RAN sends a list of co-located RANs in the coverage area of the RAN to the WTRU. The WTRU stores the list and determines whether handoff criteria is met by one of the co-located RANs. The WTRU then initiates a handoff from a current RAN to a target RAN if the handoff criteria is met by the target RAN. Alternatively, the WTRU may send a measurement report to the current RAN, whereby the current RAN determines whether handoff criteria is met by a selected one of the co-located RANs and initiates a handoff to the selected RAN if the handoff criteria is met.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 shows a handoff process in a wireless communication system configured in accordance with the present invention;

FIG. 2 is a signaling diagram of a process of a location-based WTRU-initiated handoff from an E-UTRAN to an I-WLAN in accordance with the present invention;

FIG. 3 is a signaling diagram of a process of a power-based WTRU-initiated handoff from an E-UTRAN to an I-WLAN in accordance with the present invention;

FIG. 4 is a signaling diagram of a process of a power-based WTRU-initiated handoff from an E-UTRAN to an I-WLAN without broadcasting in accordance with the present invention;

FIG. 5 is a signaling diagram of a process of a WTRU-initiated handoff from an I-WLAN to an E-UTRAN in accordance with the present invention;

FIG. 6 is a signaling diagram of a process of a WTRU-initiated handoff from an I-WLAN to an E-UTRAN without broadcasting in accordance with the present invention; and

FIG. 7 is a signaling diagram of a process of a power-based E-UTRAN-initiated handoff from an I-WLAN to an E-UTRAN in accordance with the present invention.

### DETAILED DESCRIPTION OF THE PREFERRED EMBODIMENTS

Hereafter, the terminology “WTRU” includes but is not limited to a user equipment (UE), a mobile station, a fixed or mobile subscriber unit, a pager, or any other type of device capable of operating in a wireless environment.

The features of the present invention may be incorporated into an integrated circuit (IC) or be configured in a circuit comprising a multitude of interconnecting components.

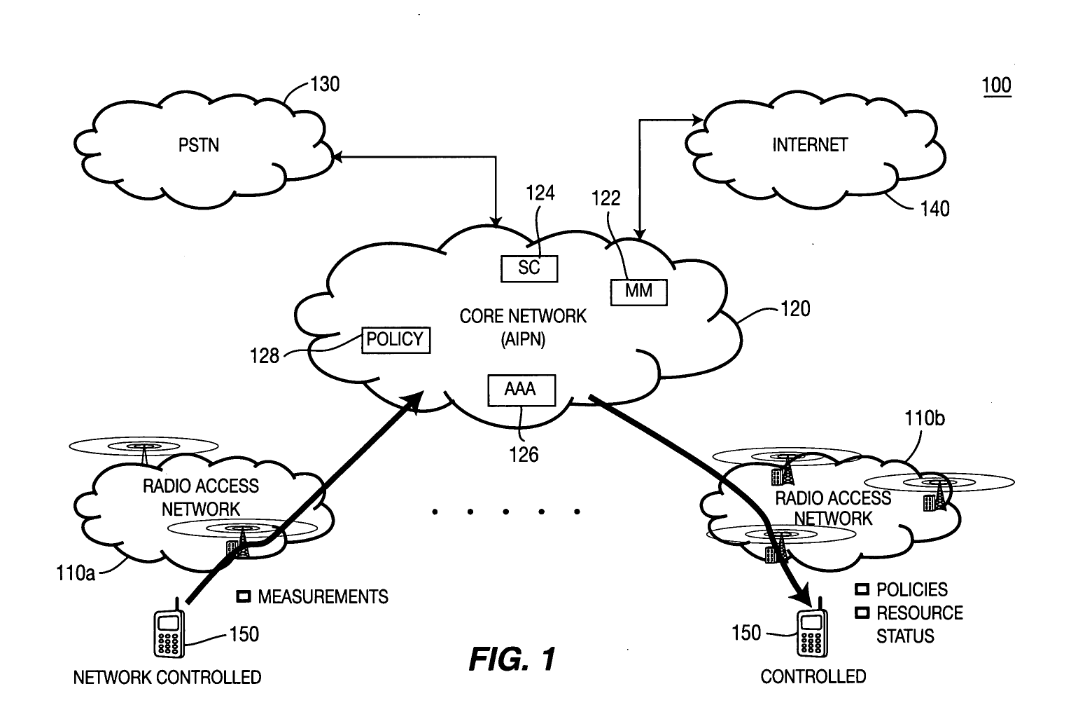

FIG. 1 shows a handoff process in a wireless communication system 100 including a plurality of RANs 110a, 110b, deployed under different RATs, and a core network 120 which may be an all IP network (AIPN). The core network 120 is connected to other networks, such as a public switching telephone network (PSTN) 130, the Internet 140, or the like. Each of the RANs 110a, 110b may be a generic access network (GAN), a GERAN, a UTRAN, an E-UTRAN, an IEEE-based interworking WLAN (I-WLAN) or any type of wireless access network.

In order to optimize mobility among diverse RANs 110a, 110b, the core network 120 provides open interfaces for mobility management (MM) 122 that allow the operator of the core network 120 to direct WTRUs 150 towards the most suitable RANs 110a, 110b. The core network 120 also provides open interfaces that allow the WTRUs 150 to access other AIPN services, such as session control (SC) 124, authentication, authorization and accounting (AAA) 126 and a policy control 128.

A WTRU 150 is a multi-mode WTRU equipped with at least two radio units configured to support communication with at least two different RATs. For example, the WTRU 150 may include one radio unit for an E-UTRAN and the other radio unit for an I-WLAN. The WTRU 150 establishes a connection to one of the RANs and may perform a handoff to a target RAN if handoff criteria is met by the target RAN.

The handoff may be initiated manually or automatically. In the manual handoff process initiated by a user of the WTRU 150, the user knows the existence of alternative RATs in its current geographic location and switches between them. The automatic handoff process may be initiated by the WTRU 150 or by the RAN 110a, 110b or the core network 120.

In the WTRU-initiated handoff, the WTRU 150 detects the existence of alternative RATs and initiates a handoff process based on the preference of the user of the WTRU 150. The WTRU 150 receives necessary information, (such as handoff policies, resource status, or the like), from the network, (i.e., an RAN 110b or the core network 120). The WTRU 150 tracks the locations of coverage areas of the RANs 110a, 110b and initiates the handoff process based on a predetermined handoff criteria.

In a system initiated handoff, the core network 120, (or the RAN 110a, 110b), recognizes that the WTRU 150 is capable of supporting multiple RATs and requests necessary information, (such as power measurements), from the WTRU 150. The core network 120, (or the RAN 110a, 110b), tracks the location of the WTRU 150 and initiates the handoff procedures based on a set of criterion, (such as the mobility of the WTRU 150, requested bandwidth, applications, load balancing, subscriber's profile, the measurement reports provided by the WTRU 150, or the like), once the WTRU 150 is within the coverage area of a target RAN.

Hereinafter the present invention will be explained with reference to an E-UTRAN and an IEEE-based I-WLAN. However, it should be noted that the present invention is applicable to any type of RANs using any type of RATs.

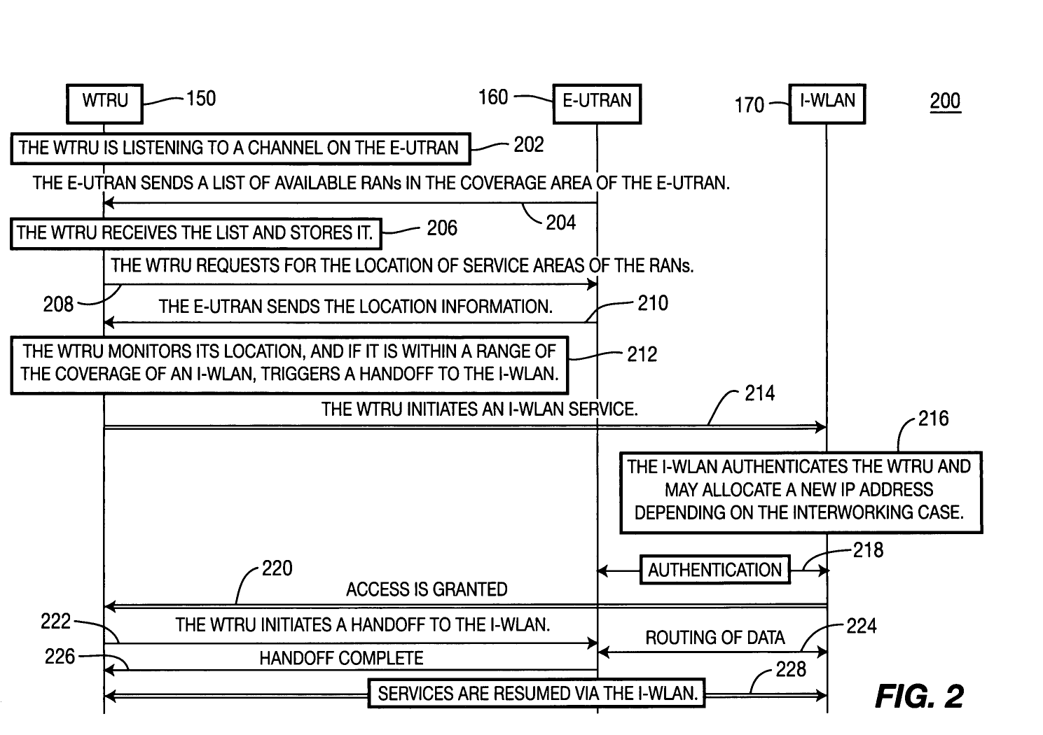

FIG. 2 is a signaling diagram of a process 200 of a WTRU-initiated handoff from an E-UTRAN 160 to an I-WLAN 170 based on location in accordance with the present invention. The WTRU 150 is currently attached to the E-UTRAN 160 and is listening to an E-UTRAN channel, such as a broadcast control channel (BCCH) (step 202). The E-UTRAN 160 sends, (i.e., broadcasts, multicasts or unicasts), a list of RANs, (e.g., I-WLANs, a UTRAN, a GERAN or a GAN), available within the coverage area of the E-UTRAN 160 (step 204). The WTRU 150 receives the list and stores it (step 206). The WTRU 150 then sends a request for the location of service areas of the RANs in the list to the E-UTRAN 160 (step 208). The E-UTRAN 160 then retrieves the location information and sends it to the WTRU 150 (steps 210). The list may include information about the service area locations, radio technologies used by the listed RANs, supported frequencies and data rates, or the like.

The WTRU 150 constantly monitors its location as it moves around the coverage area of the E-UTRAN 160. If its location is within a range of the coverage area of an alternative RAN, (such as the I-WLAN 170), the WTRU 150 triggers a handoff procedure (step 212). If the WTRU 150 determines that the WTRU 150 is within the range of the coverage area of the I-WLAN 170, the WTRU 150 sends a message to the I-WLAN 170 to initiate a WLAN service (step 214). When the I-WLAN 170 receives the message, the I-WLAN 170 initiates an authentication procedure to authenticate the WTRU 150 and may allocate a new IP address depending on the interworking case (step 216). Authentication messages are exchanged between the I-WLAN 170 and the E-UTRAN 160 (step 218). Once the WTRU 150 is authenticated, the I-WTRU 170 sends an access grant message to the WTRU 150 indicating that access to the WLAN services is granted (step 220). The WTRU 150 then initiates a handoff to the I-WLAN 170 by sending a handoff initiation message to the E-UTRAN 160 (step 222). Control messages for routing data via the I-WLAN 170 are exchanged between the E-UTRAN 160 and the I-WLAN 170 (step 224). Once a new route is established, the E-UTRAN 160 sends a handoff complete message to the WTRU 150 (step 226) and services provided to the WTRU 150 are resumed via the I-WLAN 170 (step 228).

The process 200 is applicable to a handoff between any types of RANs. For example, the process 200 may be applied to a handoff from a UTRAN to an I-WLAN. In such case, the UTRAN sends a list of available RANs in the coverage area of the UTRAN and the WTRU triggers a handoff from the UTRAN to the I-WLAN using the list based on location of the WTRU and the I-WLAN.

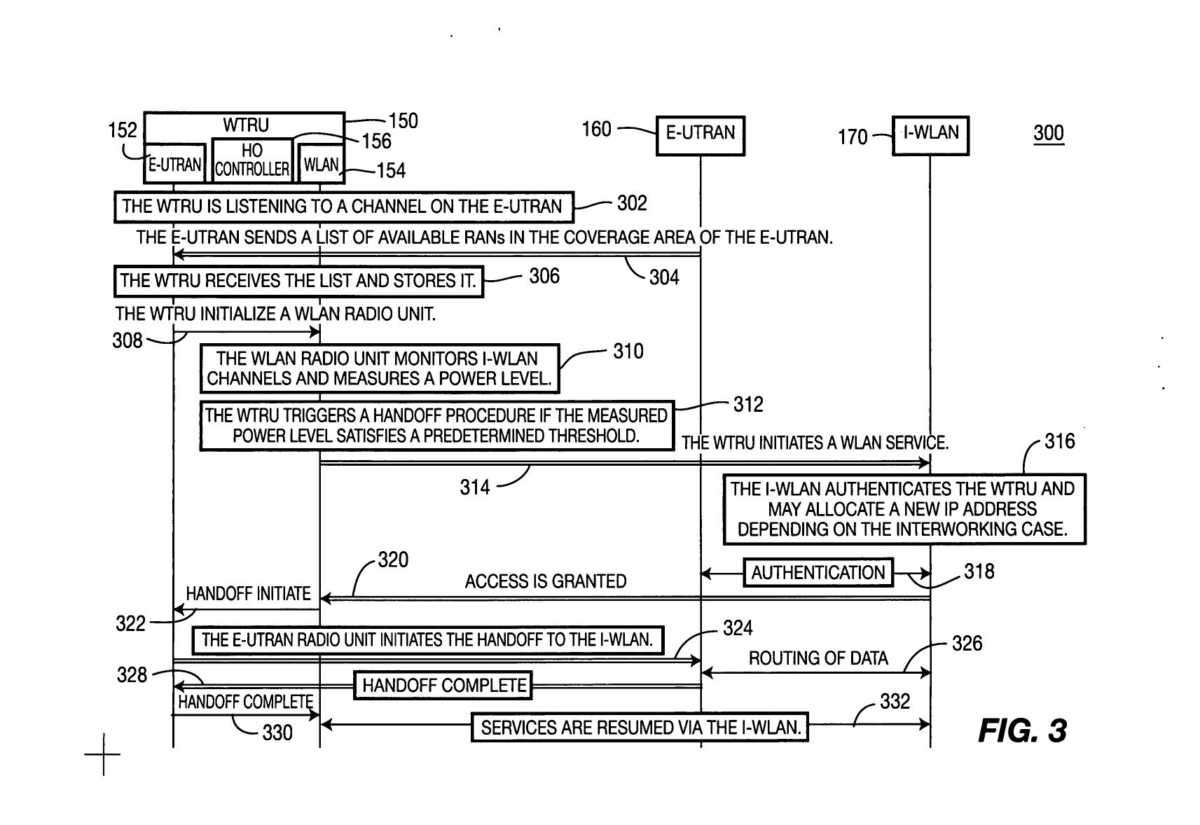

FIG. 3 is a signaling diagram of a process 300 of a WTRU-initiated handoff from an E-UTRAN 160 to an I-WLAN 170 based on a power level in accordance with the present invention. The WTRU 150 includes an E-UTRAN radio unit 152, a WLAN radio unit 154 and a handoff controller 156 so that the WTRU 150 may handoff between the E-UTRAN 160 and the I-WLAN 170. The WTRU 150 is currently attached to the E-UTRAN 160 and listens to an E-UTRAN channel, (such as a BCCH) (step 302). The E-UTRAN 160 sends, (i.e., broadcasts, multicasts or unicasts), a list of other RANs, (e.g., I-WLANs, a UTRAN, GERAN or a GAN), available within the coverage area of the E-UTRAN 160 (step 304). The E-UTRAN radio unit 152 of the WTRU 150 receives the list and stores it (step 306). The E-UTRAN radio unit 152 then initializes the WLAN radio unit 154 (step 308). The list provided by the E-UTRAN 160 preferably includes a frequency list of the I-WLAN 170 so that the WLAN radio unit 154 may search the available WLANs using the frequency list.

The WLAN radio unit 154 is then initialized and monitors WLAN channels based on the frequency list and measures a power level of signals received from the I-WLAN 170 (step 310). The handoff controller 156 triggers a handoff procedure if the measured power level satisfies a predetermined threshold (step 312). The WTRU 150 sends a message to the I-WLAN 170 to initiate WLAN services (step 314).

When the I-WLAN 170 receives the message from the WTRU 150, the I-WLAN 170 initiates an authentication procedure to authenticate the WTRU 150 and may allocate a new IP address depending on the interworking case (step 316). Authentication messages are exchanged between the I-WLAN 170 and the E-UTRAN 160 (step 318). Once the WTRU 150 is authenticated, the I-WTRU 170 sends an access grant message to the WTRU 150 (step 320). The WLAN radio unit 154 then sends a handoff initiate message to the E-UTRAN radio unit 152 (step 322). The E-UTRAN radio unit 152 then sends a message to the E-UTRAN 160 to initiate a handoff to the I-WLAN 170 (step 324). Control messages for routing of data via the I-WLAN 170 are exchanged between the E-UTRAN 160 and the I-WLAN 170 (step 326). Once a new route is established, the E-UTRAN 160 sends a handoff complete message to the E-UTRAN radio unit 152, which forwards it to the WLAN radio unit 154 (steps 328, 330). Services are then resumed via the I-WLAN (step 332).

The process 300 is applicable to a handoff between any types of RANs. For example, the process 300 may be applied to a handoff from a UTRAN to an I-WLAN. In such case, the UTRAN sends a list of available RANs in the coverage area of the UTRAN and the WTRU triggers a handoff from the UTRAN to the I-WLAN using the list based on measurement results of signals from the UTRAN and/or the I-WLAN.

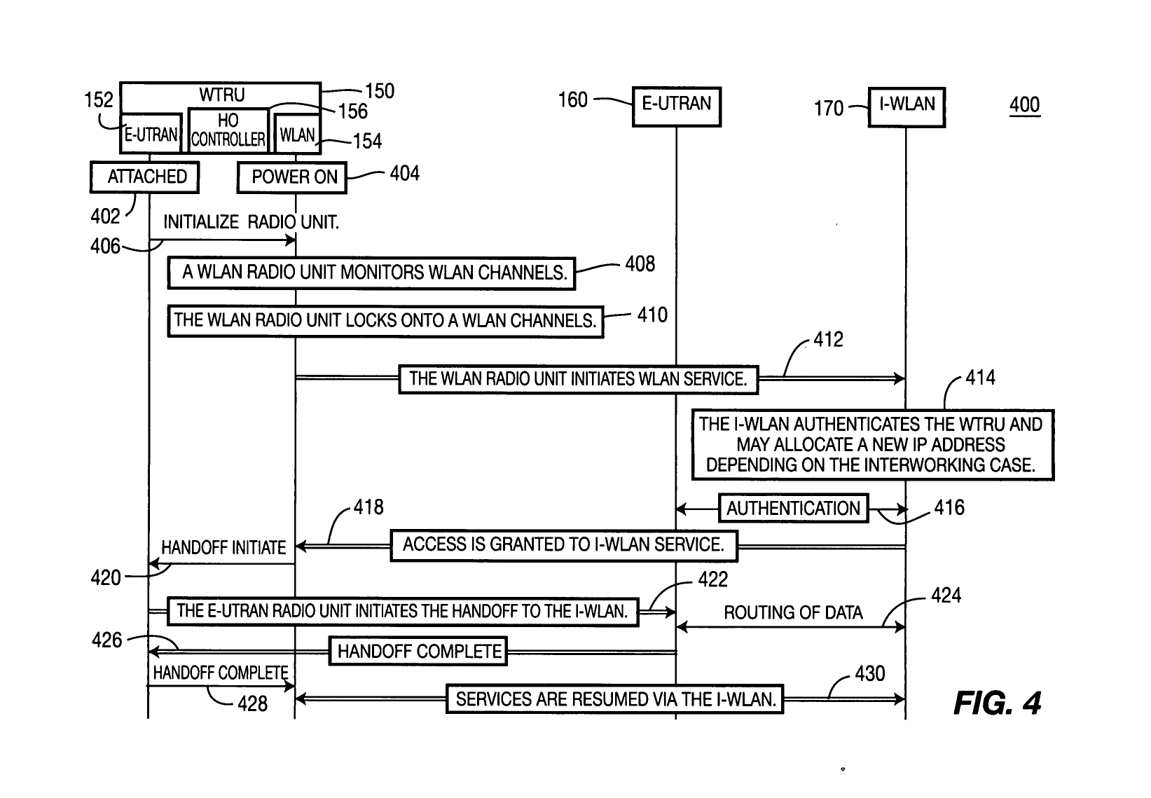

FIG. 4 is a signaling diagram of a process 400 of a WTRU-initiated handoff from an E-UTRAN 160 to an I-WLAN 170 without broadcasting based on a power level in accordance with the present invention. The WTRU 150 includes an E-UTRAN radio unit 152, a WLAN radio unit 154 and a handoff controller 156. Currently, the WTRU 150 is attached to the E-UTRAN 160 and the WLAN radio unit 154 is powered on (steps 402, 404). The E-UTRAN radio unit 152 initializes the WLAN radio unit 154 for potential handoff to the I-WLAN 170 (step 406). Since the WTRU 150 is not aware of the available RANs in the coverage area of the E-UTRAN 160, the WLAN radio unit 154 monitors WLAN channels to find any available WLAN services (step 408). If the WLAN radio unit 154 finds any WLAN channel, the WLAN radio unit 154 locks onto the WLAN channel and measures a power level of signals via the channel (step 410). If the measured power level satisfies a predetermined threshold, the handoff controller 156 triggers a handoff procedure and the WTRU 150 sends a message to the I-WLAN 170 to initiate WLAN services (step 412).

When the I-WLAN 170 receives the message, the I-WLAN 170 initiates an authentication procedure and may allocate a new IP address depending on the interworking case (step 414). Authentication messages are exchanged between the I-WLAN 170 and the E-UTRAN 160 (step 416). Once the WTRU 150 is authenticated, the I-WTRU 170 sends an access grant message to the WTRU 150 (step 418). The WLAN radio unit 154 then sends a handoff initiate message to the E-UTRAN radio unit 152 (step 420). The E-UTRAN radio unit 154 then sends a message to the E-UTRAN 160 to initiate the handoff to the I-WLAN 170 (step 422). Control messages for routing of data via the I-WLAN 170 are exchanged between the E-UTRAN 160 and the I-WLAN 170 (step 424). Once a new route is established, the E-UTRAN 160 sends a handoff complete message to the E-UTRAN radio unit 152, which forwards it to the WLAN radio unit 154 (steps 426, 428). Services are then resumed via the I-WLAN 170 (step 430).

The process 400 is applicable to a handoff between any types of RANs. For example, the process 400 may be applied to a handoff from a UTRAN to an I-WLAN. In such case, the WTRU monitors I-WLAN channels and triggers a handoff from the UTRAN to the I-WLAN based on measurement results of signals from the UTRAN and/or the I-WLAN.

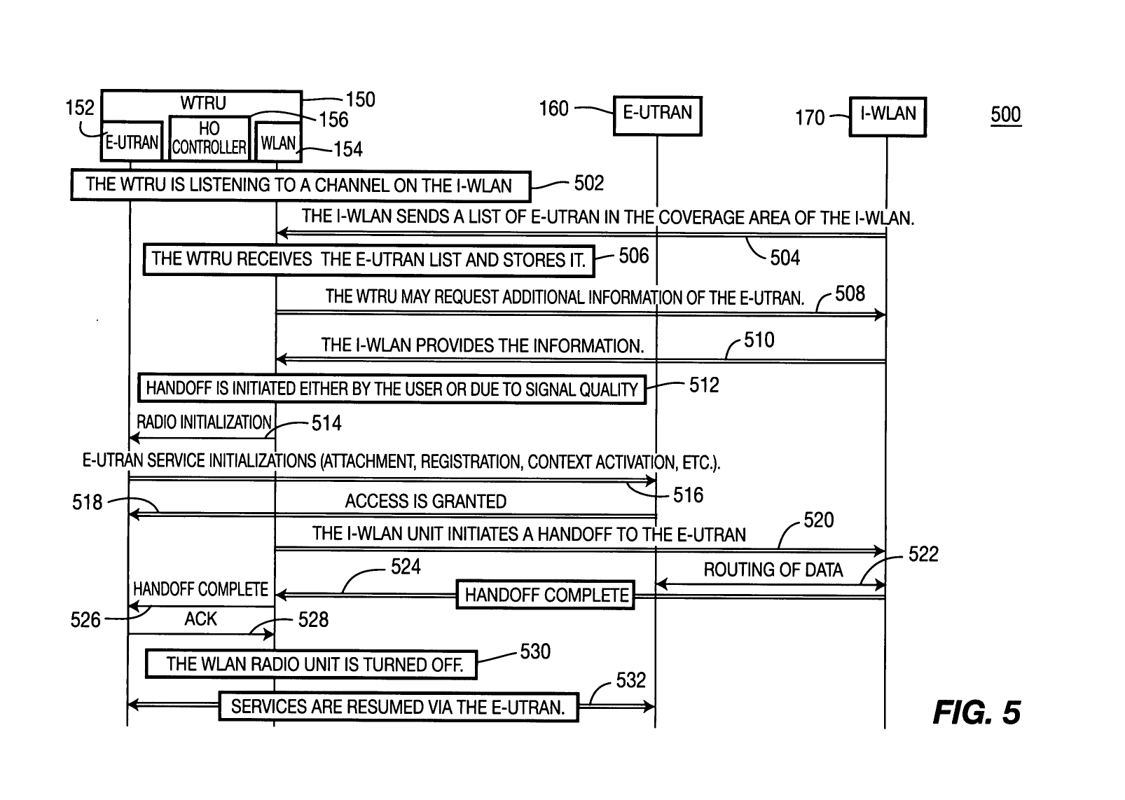

FIG. 5 is a signaling diagram of a process 500 of a WTRU-initiated handoff from an I-WLAN 170 to an E-UTRAN 160 in accordance with the present invention. The WTRU 150 includes an E-UTRAN radio unit 152, a WLAN radio unit 154 and a handoff controller 156. The WTRU 150 is currently connected to the I-WLAN 170 and listening to an I-WLAN channel (step 502).

The I-WLAN 170 sends, (i.e., broadcasts, multicasts or unicasts), a list of E-UTRAN and other services available within the coverage area of the I-WLAN 170 (step 504). The WTRU 150 receives the E-UTRAN list and stores it (step 506). The WTRU 150 may send a request for additional information of the E-UTRAN (step 508). The I-WLAN 170 then retrieves the requested information and sends it to the WTRU 150 (steps 510). The additional information includes, but is not limited to, locations of the E-UTRAN, frequencies supported by the E-UTRAN and data rates.

A handoff to the E-UTRAN 160 is initiated either by the user or automatically by the handoff controller 156 based on predetermined criteria, such as signal quality (step 512). If a handoff is initiated, the WLAN radio unit 154 sends a radio initialization signal to the E-UTRAN radio unit 152 (step 514). The E-UTRAN radio unit 152 then initiates an E-UTRAN service initialization procedure, which includes attachment, registration, context activation, or the like (step 516). The E-UTRAN 160 then sends a message to the WTRU 150 to grant access to the E-UTRAN 160 (step 518). The WLAN radio unit 154 then sends a message to the I-WLAN 170 to initiate a handoff to the E-UTRAN 160 (step 520). Control messages for routing of data via the I-WLAN 170 are exchanged between the E-UTRAN 160 and the I-WLAN 170 (step 522). Once a new route is established, the I-WLAN 170 sends a handoff complete message to the WTRU 150 (step 524). The WLAN radio unit 154 forwards the handoff complete message to the E-UTRAN radio unit 152, which responds with an acknowledgement (ACK) (steps 526, 528). The WLAN radio unit 154 is then turned off (step 530) and services are resumed via the E-UTRAN 160 (step 532).

The process 500 is applicable to a handoff between any types of RANs. For example, the process 500 may be applied to a handoff from an I-WLAN to a UTRAN. In such case, the I-WLAN sends a list of available RANs in the coverage area of the I-WLAN and the WTRU triggers a handoff from the I-WLAN to the UTRAN using the broadcast list.

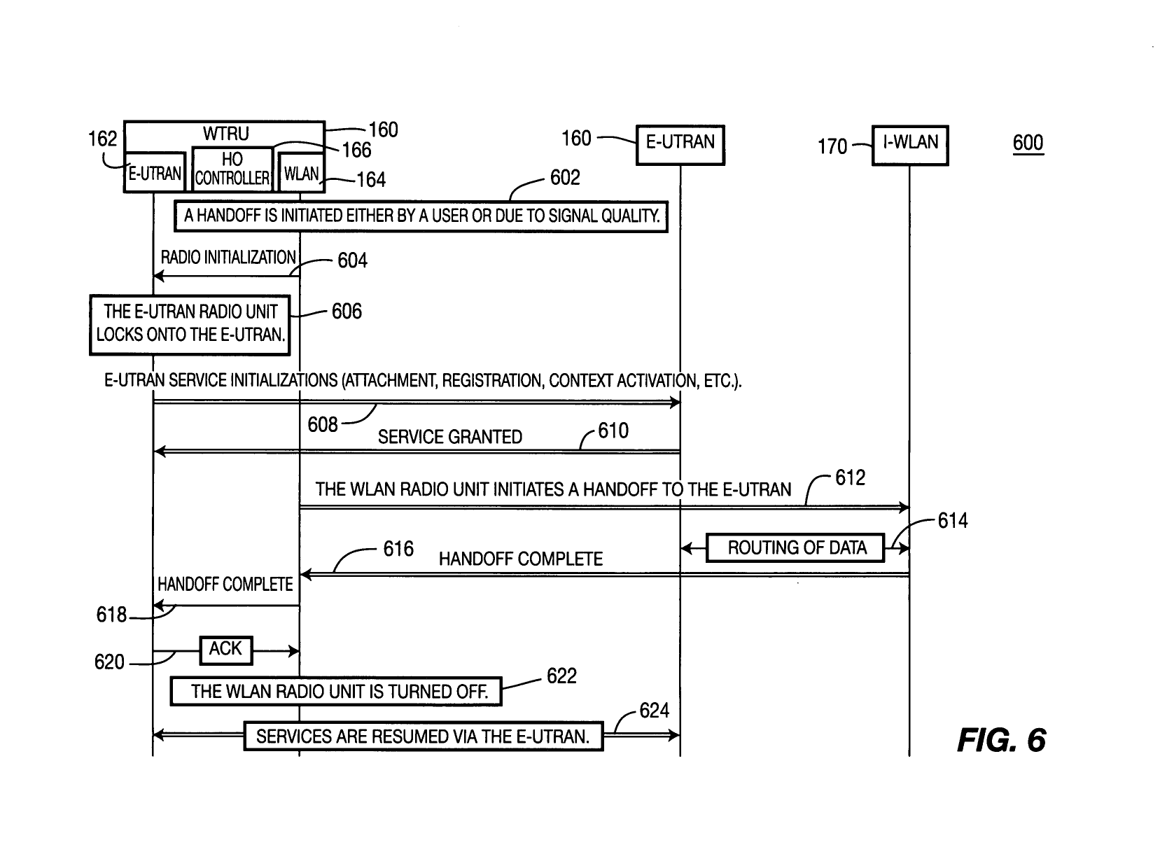

FIG. 6 is a signaling diagram of a process 600 of a WTRU-initiated handoff from an I-WLAN 170 to an E-UTRAN 160 without broadcasting in accordance with the present invention. The WTRU 150 includes an E-UTRAN radio unit 152, a WLAN radio unit 154 and a handoff controller 156. The WTRU 150 is currently connected to the I-WLAN 170. A handoff to the E-UTRAN 160 is initiated either by the user or automatically by the handoff controller 156 based on predetermined criteria, such as signal quality (step 602). The WLAN radio unit 154 sends a signal to the E-UTRAN radio unit 152 to initialize the E-UTRAN radio unit 152 (step 604). Since the WTRU 150 is not aware of the available E-UTRAN, the E-UTRAN radio unit 152 searches a channel of the E-UTRAN 160 and locks onto the E-UTRAN channel once it is found (step 606).

The E-UTRAN radio unit 152 then initiates an E-UTRAN service initialization procedure, which includes attachment, registration, context activation, or the like (step 608). If the E-UTRAN 160 determines to grant service to the user, the E-UTRAN 160 sends a message to the WTRU 150 to grant access to the E-UTRAN 160 (step 610). The WLAN radio unit 154 then sends a message to the I-WLAN 170 to initiate a handoff to the E-UTRAN 160 (step 612). Control messages for routing of data via the I-WLAN 170 are exchanged between the E-UTRAN 160 and the I-WLAN 170 (step 614). Once a new route is established, the I-WLAN 170 sends a handoff complete message to the WTRU 150 (step 616). The WLAN radio unit 154 forwards the handoff complete message to the E-UTRAN radio unit 152, which responds with an ACK (steps 618, 620). The WLAN radio unit 154 is then turned off (step 622) and services are resumed via the E-UTRAN 160 (step 614).

The process 600 is applicable to a handoff between any types of RANs. For example, the process 200 may be applied to a handoff from an I-WLAN to a UTRAN.

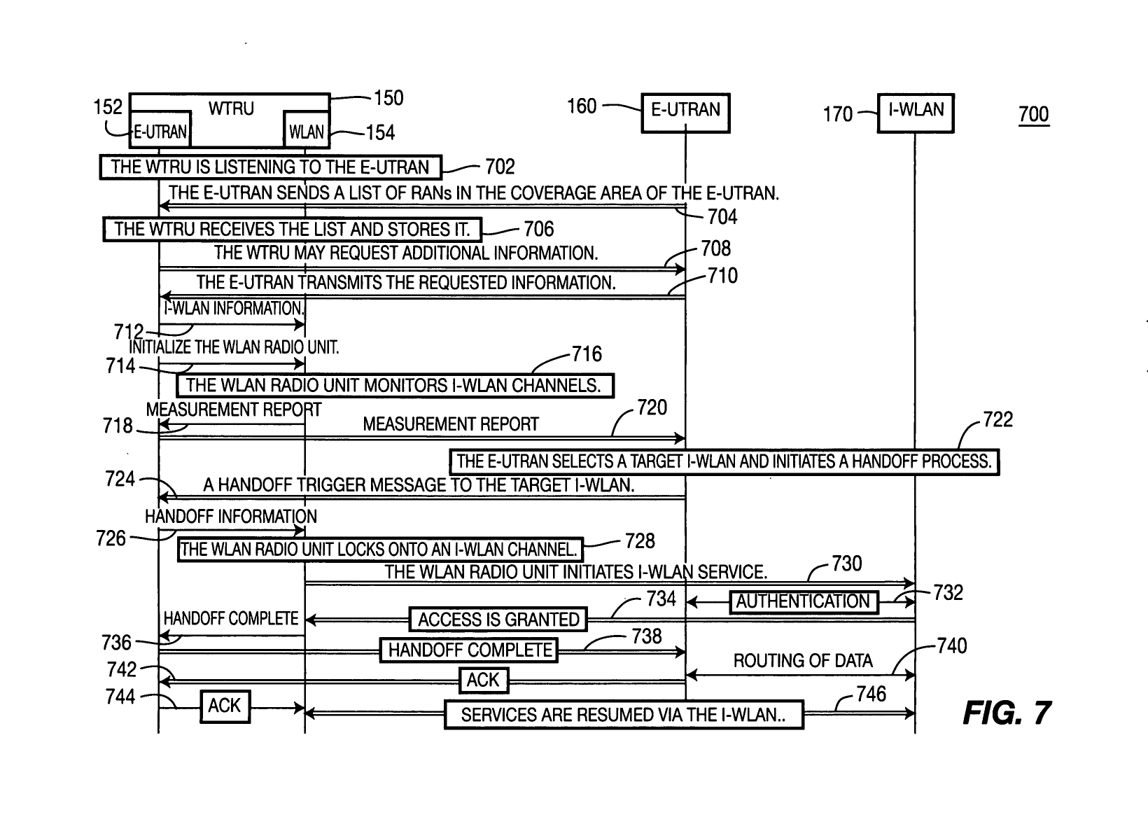

FIG. 7 is a signaling diagram of a process 700 of an E-UTRAN-initiated handoff from an I-WLAN 170 to an E-UTRAN 160 based on a power level in accordance with the present invention. The WTRU 150 includes an E-UTRAN radio unit 152 and a WLAN radio unit 154. The WTRU 150 is currently attached to the E-UTRAN 160 and listening to an E-UTRAN channel, (such as a BCCH) (step 702). The E-UTRAN 160 sends, (i.e., broadcasts, multicasts or unicasts), a list of RANs, (e.g., I-WANs, a UTRAN, a GERAN or a GAN), available within the coverage area of the E-UTRAN 160 (step 704). The WTRU 150 receives the list and stores it (step 706). The WTRU 150 sends a request for additional information, such as the location of service areas of the RANs (step 708). The E-UTRAN 160 then retrieves the requested information and sends it to the WTRU 150 (steps 710). The information may include information about the service area locations, radio technologies used by the RANs, supported frequencies and data rates, or the like.

The E-UTRAN radio unit 152 then forwards the I-WLAN information to the WLAN radio unit 154 including a frequency list to help the WLAN radio unit searching the available WLANs and initializes the WLAN radio unit (steps 712, 714). The WLAN radio unit 154 monitors the WLAN channels based on the frequency list and measures a power level of signals from the I-WLAN 170 (step 716). The WLAN radio unit 154 then sends the measurement report to the E-UTRAN radio unit 152 (step 718) and the E-UTRAN radio unit 152 forwards the measurement report to the E-UTRAN 160 (step 720).

The E-UTRAN 160 selects a target I-WLAN based on the measurement report and initiates a handoff process (step 722). The E-UTRAN 160 sends a handoff trigger message including information about the target I-WLAN to the WTRU 150 (step 724). The E-UTRAN radio unit 152 forwards the information to the WLAN radio unit 154 (step 726). The WLAN radio unit 154 then searches a channel of the target WLAN based on the information and locks onto the target WLAN (step 728). The WLAN radio unit 154 sends a message to the I-WLAN 170 to initiate WLAN services (step 730).

When the I-WLAN 170 receives the message, the I-WLAN 170 initiates an authentication procedure and may allocate a new IP address depending on the interworking case. Authentication messages are exchanged between the I-WLAN 170 and the E-UTRAN 160 (step 732). Once the WTRU is authenticated, the I-WLAN 170 sends an access grant message to the WTRU 150 (step 734). The WLAN radio unit 154 then sends a handoff complete message to the E-UTRAN radio unit 152 (step 736). The E-UTRAN radio unit 152 then forwards the handoff complete message to the E-UTRAN 160 (step 738). Control messages for routing of data via the I-WLAN 170 are exchanged between the E-UTRAN 160 and the I-WLAN 170 (step 740). Once a new route is established, the E-UTRAN 160 then sends an ACK to the E-UTRAN radio unit 152 (step 742) and the E-UTRAN radio unit 152 forwards the ACK to the WLAN radio unit 154 (step 744). Services are then resumed via the I-WLAN 170 (step 746).

The process 700 is applicable to a handoff between any types of RANs. For example, the process 700 may be applied to a handoff from a UTRAN to an I-WLAN. In such case, the UTRAN sends a list of available RANs in the coverage area of the UTRAN and the WTRU reports measurement results to the UTRAN and the UTRAN triggers a handoff from the UTRAN to the I-WLAN based on the measurement results.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system including a plurality of radio access networks (RANs) deployed under different radio access technologies (RATs) and a wireless transmit/receive unit (WTRU), a method of initiating a handoff between the RANs, the method comprising:
a first RAN sending a list to the WTRU, the list including RANs co-located in a coverage area of the first RAN;
the WTRU receiving the list from the first RAN and storing the list;
the WTRU determining whether a handoff criteria is met by one of the co-located RANs and selecting one of the co-located RANs that meets the handoff criteria; and
the WTRU initiating a handoff from the first RAN to the selected RAN.

2. The method of claim 1 further comprising:
the WTRU requesting information regarding service area location of the co-located RANs from the first RAN, whereby the WTRU initiates the handoff to the selected RAN if the service area location of the selected RAN is within a predetermined range.

3. The method of claim 2 wherein the WTRU continuously determines whether the service area location of the selected RAN is within the predetermined range as the WTRU moves.

4. The method of claim 1 further comprising:
the WTRU measuring a power level of signals received from the co-located RANs and the first RAN, whereby the WTRU initiates the handoff to the selected RAN if a power level of signals received from the selected RAN exceeds a power level of signals received from the first RAN.

5. The method of claim 1 further comprising:
the WTRU requesting additional information including at least one of service locations, radio technologies, and frequencies and data rates of the co-located RANs in the list, whereby the WTRU triggers the handoff based on the additional information.

6. The method of claim 1 wherein the first RAN is of an evolved universal mobile telecommunication systems (UMTS) terrestrial radio access network (E-UTRAN) and the co-located RAN is at least one of a UMTS terrestrial radio access network (UTRAN), a GSM/EDGE radio access network (GERAN), a generic access network (GAN) and an IEEE-based inter-working wireless local area network (I-WLAN).

7. The method of claim 1 wherein the first RAN is an IEEE-based inter-working wireless local area network (I-WLAN) and the co-located RAN is one of an evolved universal mobile telecommunication systems (UMTS) terrestrial radio access network (E-UTRAN), a UMTS terrestrial radio access network (UTRAN), a GSM/EDGE radio access network (GERAN) and at least one of a generic access network (GAN).

8. The method of claim 1 wherein the first RAN is a universal mobile telecommunication systems (UMTS) terrestrial radio access network (UTRAN) and the co-located RAN is an IEEE-based inter-working wireless local area network (I-WLAN).

9. The method of claim 1 wherein the first RAN is an IEEE-based inter-working wireless local area network (I-WLAN) and the co-located RAN is a universal mobile telecommunication systems (UMTS) terrestrial radio access network (UTRAN).

10. A wireless communication system comprising:
a plurality of radio access networks (RANs) deployed under different radio access technologies (RATs), a first one of the RANs configured to send a list of RANs co-located in a coverage area of the first RAN; and
a wireless transmit/receive unit (WTRU) configured to: i) receive the list from the first RAN, ii) determine whether a handoff criteria is met by one of the co-located RANs, iii) select one of the co-located RANs that meet the handoff criteria, and iv) initiate a handoff from the first RAN to the selected RAN.

11. The system of claim 10 wherein the WTRU is configured to request information regarding service area location of the co-located RANs from the first RAN, monitor the service area location of the WTRU and the selected RAN, and initiate the handoff to the selected RAN if the service area location of the selected RAN is within a predetermined range.

12. The system of claim 10 wherein the WTRU is configured to measure a power level of signals received from the co-located RANs and the first RAN, whereby the WTRU initiates the handoff to the selected RAN based on the measured power level.

13. The system of claim 10 wherein the WTRU is configured to request additional information including at least one of service area locations, radio technologies, and frequencies and data rates of the co-located RANs, whereby the WTRU triggers the handoff based on the additional information.

14. The system of claim 10 wherein the first RAN is an evolved universal mobile telecommunication systems (UMTS) terrestrial radio access network (E-UTRAN) and the co-located RAN is at least one of a UMTS terrestrial radio access network (UTRAN), a GSM/EDGE radio access network (GERAN), a generic access network (GAN) and an IEEE-based inter-working wireless local area network (I-WLAN).

15. The system of claim 10 wherein the first RAN is an IEEE-based inter-working wireless local area network (I-WLAN) and the co-located RAN is at least one of an evolved universal mobile telecommunication systems (UMTS) terrestrial radio access network (E-UTRAN), a UMTS terrestrial radio access network (UTRAN), a GSM/EDGE radio access network (GERAN) and a generic access network (GAN).

16. The system of claim 10 wherein the first RAN is a universal mobile telecommunication systems (UMTS) terrestrial radio access network (UTRAN) and the co-located RAN is an IEEE-based inter-working wireless local area network (I-WLAN).

17. The system of claim 10 wherein the first RAN is an IEEE-based inter-working wireless local area network (I-WLAN) and the co-located RAN is a universal mobile telecommunication systems (UMTS) terrestrial radio access network (UTRAN).

18. In a wireless communication system including a plurality of radio access networks (RANs) deployed under different radio access technologies (RATs) and at least one wireless transmit/receive unit (WTRU), a method of initiating a handoff between the RANs, the method comprising:
a first RAN sending a list to the WTRU, the list including co-located RANs in a coverage area of the first RAN;
the WTRU receiving the list from the first RAN and storing the list;
the WTRU measuring quality of signals received from the co-located RANs;
the WTRU sending a signal quality measurement report to the first RAN;
the first RAN determining whether a handoff criteria is met by the co-located RANs and selecting one of the co-located RANs that meet the handoff criteria; and
the first RAN initiating a handoff from the first RAN to the selected RAN.

19. The method of claim 18 further comprising:
the WTRU requesting additional information including at least one of service locations, radio technologies and frequencies and data rates of the co-located RANs to the first RAN, whereby the WTRU uses the additional information in measuring the signal quality.

20. The method of claim 18 wherein the first RAN is an evolved universal mobile telecommunication systems (UMTS) terrestrial radio access network (E-UTRAN) and the co-located RAN is at least one of a UMTS terrestrial radio access network (UTRAN), a GSM/EDGE radio access network (GERAN), a generic access network (GAN) and an IEEE-based inter-working wireless local area network (I-WLAN).

21. The method of claim 18 wherein the first RAN is an IEEE-based inter-working wireless local area network (I-WLAN) and the co-located RAN is at least one of an evolved universal mobile telecommunication systems (UMTS) terrestrial radio access network (E-UTRAN), a UMTS terrestrial radio access network (UTRAN), a GSM/EDGE radio access network (GERAN) and a generic access network (GAN).

22. The method of claim 18 wherein the first RAN is a universal mobile telecommunication systems (UMTS) terrestrial radio access network (UTRAN) and the co-located RAN is an IEEE-based inter-working wireless local area network (I-WLAN).

23. The method of claim 18 wherein the first RAN is an IEEE-based inter-working wireless local area network (I-WLAN) and the co-located RAN is a universal mobile telecommunication systems (UMTS) terrestrial radio access network (UTRAN).

24. A wireless communication system comprising:
a plurality of radio access networks (RANs) deployed under different radio access technologies (RATs), a first one of the RANs configured to send a list of RANs co-located in a coverage area of the first RAN and initiate a handoff to a selected RAN if handoff criteria is met by the selected RAN based on a measurement report received by the first RAN; and
a wireless transmit/receive unit (WTRU) configured to measure quality of signals received from the co-located RANs and send a signal quality measurement report to the first RAN.

25. The system of claim 24 wherein the WTRU is configured to request additional information including at least one of service locations, radio technologies and frequencies and data rates of the co-located RANs to the first RAN, whereby the WTRU uses the additional information in measuring the signal quality.

26. The system of claim 24 wherein the first RAN is an evolved universal mobile telecommunication systems (UMTS) terrestrial radio access network (E-UTRAN) and the co-located RAN is at least one of a UMTS terrestrial radio access network (UTRAN), a GSM/EDGE radio access network (GERAN), a generic access network (GAN) and an IEEE-based inter-working wireless local area network (I-WLAN).

27. The system of claim 24 wherein the first RAN is an IEEE-based inter-working wireless local area network (I-WLAN) and the co-located RAN is one of an evolved universal mobile telecommunication systems (UMTS) terrestrial radio access network (E-UTRAN), a UMTS terrestrial radio access network (UTRAN), a GSM/EDGE radio access network (GERAN) and a generic access network (GAN).

28. The system of claim 24 wherein the first RAN is a universal mobile telecommunication systems (UMTS) terrestrial radio access network (UTRAN) and the co-located RAN is an IEEE-based inter-working wireless local area network (I-WLAN).

29. The system of claim 24 wherein the first RAN is an IEEE-based inter-working wireless local area network (I-WLAN) and the co-located RAN is a universal mobile telecommunication systems (UMTS) terrestrial radio access network (UTRAN).

30. In a wireless communication system including an evolved universal mobile telecommunication system (UMTS) terrestrial radio access network (E-UTRAN) and a wireless transmit/receive unit (WTRU), a method for initiating a handoff from the E-UTRAN to another radio access network (RAN), the method comprising:
the E-UTRAN sending a list to the WTRU, the list including RANs co-located in a coverage area of the E-UTRAN;
the WTRU receiving the list from the E-UTRAN and storing the list;
the WTRU determining whether a handoff criteria is met by one of the co-located RANs and selecting one of the co-located RANs that meets the handoff criteria; and
the WTRU initiating a handoff from the E-UTRAN to the selected RAN.

31. The method of claim 30 further comprising:
the WTRU requesting information regarding service area location of the co-located RANs from the E-UTRAN, whereby the WTRU initiates the handoff to the selected RAN if the service area location of the selected RAN is within a predetermined range.

32. The method of claim 30 further comprising:
the WTRU measuring a power level of signals received from the co-located RANs and the E-UTRAN, whereby the WTRU initiates the handoff to the selected RAN if a power level of signals received from the selected RAN exceeds a power level of signals received from the E-UTRAN.

33. The method of claim 30 further comprising:
the WTRU requesting additional information including at least one of service locations, radio technologies, and frequencies and data rates of the co-located RANs in the list, whereby the WTRU triggers the handoff based on the additional information.

34. A wireless communication system comprising:
an evolved universal mobile telecommunication system (UMTS) terrestrial radio access notwork (E-UTRAN) configured to send a list of radio access networks (RANs) co-located in a coverage area of the E-UTRAN;
at least one co-located RAN deployed under different radio access technology (RAT); and
a wireless transmit/receive unit (WTRU) configured to: i) receive the list from the E-UTRAN, ii) determine whether a handoff criteria is met by one of the co-located RANs, iii) select one of the co-located RANs that meet the handoff criteria, and iv) initiate a handoff from the E-UTRAN to the selected RAN.

35. The system of claim 34 wherein the WTRU is configured to request information regarding service area location of the co-located RANs from the E-UTRAN, monitor the service area location of the WTRU and the selected RAN, and initiate the handoff to the selected RAN if the service area location of the selected RAN is within a predetermined range.

36. The system of claim 34 wherein the WTRU is configured to measure a power level of signals received from the co-located RANs and the E-UTRAN, whereby the WTRU initiates the handoff to the selected RAN based on the measured power level.

37. The system of claim 34 wherein the WTRU is configured to request additional information including at least one of service area locations, radio technologies, and frequencies and data rates of the co-located RANs, whereby the WTRU triggers the handoff based on the additional information.

38. In a wireless communication system including an evolved universal mobile telecommunication system (UMTS) terrestrial radio access network (E-UTRAN) and a wireless transmit/receive unit (WTRU), a method for initiating a handoff from a second radio access network (RAN) to the E-UTRAN, the method comprising:
the second RAN sending a list to the WTRU, the list including E-UTRAN co-located in a coverage area of the E-UTRAN;
the WTRU receiving the list from the second RAN and storing the list;
the WTRU determining whether a handoff criteria is met by the E-UTRAN; and
the WTRU initiating a handoff from the second RAN to the E-UTRAN if the handoff criteria is met.

39. The method of claim 38 further comprising:
the WTRU requesting additional information including at least one of service locations, radio technologies, and frequencies and data rates of the E-UTRAN, whereby the WTRU triggers the handoff based on the additional information.

40. A wireless communication system comprising:
an evolved universal mobile telecommunication system (UMTS) terrestrial radio access network (E-UTRAN)
at least one alternative radio access network (RAN) co-located in a coverage area of the E-UTRAN, the alternative RAN configured to send a list of E-UTRAN available in a coverage area of the alternative RAN; and
a wireless transmit/receive unit (WTRU) configured to: i) receive the list from the alternative RAN, ii) determine whether a handoff criteria is met by the E-UTRAN, and iii) initiate a handoff from the alternative RAN to the E-UTRAN if the handoff criteria is met.

41. The system of claim 40 wherein the WTRU is configured to request additional information including at least one of service area locations, radio technologies, and frequencies and data rates of the E-UTRAN, whereby the WTRU triggers the handoff based on the additional information.

42. In a wireless communication system including an evolved universal mobile telecommunication system (UMTS) terrestrial radio access network (E-UTRAN), an interworking wireless local area network (I-WLAN) and a wireless transmit/receive unit (WTRU), a method for initiating a handoff between the E-UTRAN and the I-WLAN, the method comprising:
the WTRU monitoring I-WLAN channels while the WTRU is attached to the E-UTRAN;
the WTRU locking onto a detected I-WLAN channel; and
the WTRU initiating a handoff procedure if criteria for a handoff to the I-WLAN is met.

43. A wireless communication system comprising:
an evolved universal mobile telecommunication system (UMTS) terrestrial radio access network (E-UTRAN);
an IEEE-based interworking wireless local area network (I-WLAN);
a wireless transmit/receive unit (WTRU) comprising:
an E-UTRAN radio unit; and
an I-WLAN radio unit; and
a handoff controller configured to i) monitor I-WLAN channels while the WTRU is attached to the E-UTRAN, ii) lock onto a detected WLAN channel, and iii) initiate a handoff procedure if criteria for a handoff to the I-WLAN is met.

44. In a wireless communication system including an evolved universal mobile telecommunication system (UMTS) terrestrial radio access network (E-UTRAN), an interworking wireless local area network (I-WLAN) and a wireless transmit/receive unit (WTRU), a method for initiating a handoff between the E-UTRAN and the I-WLAN, the method comprising:
the WTRU monitoring E-UTRAN channels while the WTRU is attached to the I-WLAN;
the WTRU locking onto a detected E-UTRAN channel; and
the WTRU initiating a handoff procedure if criteria for a handoff from the I-WLAN to the E-UTRAN is met.

45. A wireless communication system comprising:
an evolved universal mobile telecommunication system (UMTS) terrestrial radio access network (E-UTRAN);
an IEEE-based interworking wireless local area network (I-WLAN);
a wireless transmit/receive unit (WTRU) comprising:
an E-UTRAN radio unit; and
an I-WLAN radio unit; and
a handoff controller configured to i) monitor E-UTRAN channels while the WTRU is attached to the I-WLAN, ii) lock onto a detected E-UTRAN channel, and iii) initiate a handoff procedure if criteria for a handoff to the E-UTRAN is met.
